(19) United States
(12) Patent Application Publication
(10) Pub. No.: US 2026/0189599 A1
(43) Pub. Date: Jul. 2, 2026

(54) COMMUNICATION NETWORK MANAGEMENT SYSTEM WITH FEDERATED LEARNING

(71) Applicant: AT&T Intellectual Property I, L.P., Atlanta, GA (US)

(72) Inventors: Ayush Kumar, East Brunswick, NJ (US); Rajasingh Nagarathinam, Marlboro, NJ (US); Vinodh Pemmasani, Parsippany, NJ (US); Bin Xie, Morganville, NJ (US); Chandrasekhar Thondikulum, Manalapan, NJ (US); Justine Lau, Fords, NJ (US); Isilay Baran, Morganville, NJ (US); James Strydio, Middletown, NJ (US); Nathan Grube, Trophy Club, TX (US)

(21) Appl. No.: 19/004,377

(22) Filed: Dec. 29, 2024

(51) Int. Cl. H04L 9/40; G06N 20/20

(52) U.S. Cl. CPC H04L 63/1441; G06N 20/20; H04L 63/1425

(57) ABSTRACT

A processing system may obtain first data samples relating to a first network zone and second data samples relating to a second zone of the communication network, and train a first machine learning model for a first prediction task using the first data samples and a second machine learning model for a second prediction task using the second data samples, where the prediction tasks are of a same type. The processing system may next tune an aggregated machine learning model in accordance with first parameters of the first machine learning model and second parameters of the second machine learning model, where the tuning comprises generating third parameters for the aggregated machine learning model, apply an input data vector to the aggregated machine learning model to obtain an output, and perform a remedial action in the communication network in response to the output.

The present disclosure relates generally to telecommunication network operations, and more particularly to devices, computer-readable media, and methods for tuning an aggregated machine learning model in accordance with first parameters of a first machine learning model relating to a first network zone and second parameters of a second machine learning model relating to a second network zone.

### BACKGROUND

Anomaly detection algorithms are increasingly used in the realm of network management, cybersecurity, and threat detection. However, most solutions produce large amounts of output which may still need to be manually scanned. For instance, many algorithms conservatively produce a significant number of alarms, many of which may be false. Similarly, a single network event may produce many alarms relating to various network elements. This may require substantial manual effort to find and address a root cause from among hundreds of alarms relating to secondary or indirect impacts.

### SUMMARY

In one example, the present disclosure discloses a method, computer-readable medium, and apparatus for tuning an aggregated machine learning model in accordance with first parameters of a first machine learning model relating to a first network zone and second parameters of a second machine learning model relating to a second network zone. For example, a processing system including at least one processor may obtain first data samples relating to a first network zone of a communication network and second data samples relating to a second zone of the communication network. The processing system may next train a first machine learning model for a first prediction task associated with the first network zone using the first data samples and train a second machine learning model for a second prediction task associated with the second network zone using the second data samples, where the first prediction task and the second prediction task are both of a same first type of prediction task. In addition, the processing system may tune an aggregated machine learning model in accordance with first parameters of the first machine learning model and second parameters of the second machine learning model, where the tuning comprises generating third parameters for the aggregated machine learning model as a function of complementary parameters from the first parameters and the second parameters. The processing system may then apply an input data vector to the aggregated machine learning model to obtain an output in accordance with the first type of prediction task and may perform at least one remedial action in the communication network in response to the output.

### BRIEF DESCRIPTION OF THE DRAWINGS

The teaching of the present disclosure can be readily understood by considering the following detailed description in conjunction with the accompanying drawings, in which:

FIG. 1 illustrates an example system related to the present disclosure;

FIG. 2 illustrates an example federated machine learning model platform in accordance with the present disclosure;

FIG. 3 illustrates a flowchart of an example method for tuning an aggregated machine learning model in accordance with first parameters of a first machine learning model relating to a first network zone and second parameters of a second machine learning model relating to a second network zone; and

FIG. 4 illustrates an example high-level block diagram of a computing device specifically programmed to perform the steps, functions, blocks, and/or operations described herein.

To facilitate understanding, identical reference numerals have been used, where possible, to designate identical elements that are common to the figures.

### DETAILED DESCRIPTION

The present disclosure broadly discloses methods, computer-readable media, and apparatuses for tuning an aggregated machine learning model in accordance with first parameters of a first machine learning model relating to a first network zone and second parameters of a second machine learning model relating to a second network zone. In particular, examples of the present disclosure provide a federated predictive machine learning system to detect anomalies in network status data, where regionalized machine learning models may learn from decentralized data sources without the need to centralize the data, thus preserving privacy and reducing data transmission costs. At the same time, collaborative learning via an aggregated (e.g., centralized) machine learning model facilitates the utilization of insights from diverse network regions, such as metro areas, e.g., Philadelphia, Dallas, etc., or other regions, e.g., New England, Mid-Atlantic, Midwest, Southeast, etc. In addition, regional learning and sharing capabilities of the present disclosure not only enhance the predictive accuracy of alert mechanisms by incorporating a broader spectrum of data patterns, but also ensure that the machine learning models are continuously upgraded from various segments (e.g., zone, regions, or the like) of the network. This approach is particularly relevant for mobility network elements, which form the backbone of layer three services in 4G and 5G networks, and which can be extended to future technologies like 6G, 7G, and beyond. Examples of the present disclosure thus provide a more scalable, efficient, and effective solution for managing network alerts.

During system outages or other network issues, alert flooding is a common occurrence. A high volume of alerts can overwhelm a network operator, making it difficult to quickly identify and address the root cause(s), and in many cases leading to prolonged downtime and increased operational costs. Traditional network management systems may rely on reactive measures, addressing issues only after they have occurred. This approach is not only inefficient but also increases the risk of prolonged outages and higher maintenance costs. To reduce the impact of alert flooding, various techniques may be employed, such as threshold-based alerting, event correlation engines, hierarchical alerting system, or the like. For instance, many network management systems have implemented threshold-based alerting mechanisms to generate alerts when certain predefined performance thresholds are exceeded. Higher thresholds may be set to reduce the sensitivity and hence the number of alerts. Similarly, event correlation engines may associate multiple alerts to help identify the underlying issue. By grouping related alerts, these engines aim to reduce the overall number of alerts and help network administrators focus on the root cause. In addition, alerts may be prioritized or suppressed based on their severity and potential impact on the network. By categorizing alerts into different levels, such as critical, major, and minor, administrators can focus on the most important issues first. In contrast, examples of the present disclosure address the immediate challenge of alert flooding while further enhancing the overall resilience of the network infrastructure and efficiency of operation through predictive maintenance and decentralized data learning.

To further illustrate, examples of the present disclosure provide a machine learning (ML)-based network monitoring system that may incorporate regional level data collection. This may include data pre-processing, e.g., where network performance indicator metrics such as packet loss, latency, jitter, bandwidth utilization, error rates, etc. may be gathered and refined through normalization, outlier detection, and transformation to ensure high-quality inputs and accurate extraction to create relevant features that capture relevant patterns and trends. For instance, in one example, data pre-processing may include generating time-series features, aggregating metrics over time windows, and deriving statistical summaries. The present disclosure may then train regionalized machine learning models (MLMs) on historical network data to identify complex, non-linear relationships indicative of potential network issues (e.g., network anomalies). For example, these MLMs may be configured/trained to perform predictive analytics, to forecast future network states, to identify anomalies, and so forth. This approach decentralizes model training on a regional level, allowing local training on data from different network regions such as Philadelphia, Dallas, New York, etc., thus preserving data privacy and reducing transmission costs.

In a next phase, the present disclosure may then tune an aggregated machine learning model in accordance with parameters of the regionally trained MLMs. For instance, parameters of the aggregated MLM (e.g., neuron weights, biases, etc.) may be generated as a function of complementary/respective parameters from the regionally trained MLMs. The aggregated MLM may then be used for live anomaly detection/prediction. In one example, testing data may be applied to the aggregated MLM to determine an error rate, which may be applied to the regionally trained MLMs to update respective model parameters via backpropagation. In one example, function(s) for deriving parameters of the aggregated MLM from parameters of the regionally trained MLMs may be updated via reinforcement learning (RL). In this way, the aggregated MLM may incorporate learning/knowledge from experiences in different regions. Notably, the underlying training data may remain localized, thus further preserving privacy, enhancing security, and reducing network load by reducing the volume of data in transit.

In an illustrative example, suppose a major storm hits Philadelphia, causing widespread network outage. Collaborative learning allows the local/regional MLM to quickly learn from the storm's impact on network traffic, hardware failures, customer service disruptions, and/or the like. Meanwhile, in Dallas, ongoing hardware upgrades might introduce different types of network anomalies. By federating learning from these regionally trained MLMs, the aggregated MLM may be adept at handling both weather-induced and hardware-induced issues, thus enhancing the overall network resilience. Accordingly, examples of the present disclosure preserve data privacy, as sensitive network data remains localized. In a carrier network networks, this means user/subscriber data, which might include call logs or internet usage statistics, is never exposed unnecessarily. Secondly, it reduces transmission costs since there is no need to centralize large volumes of data, which is particularly important for bandwidth-constrained environments.

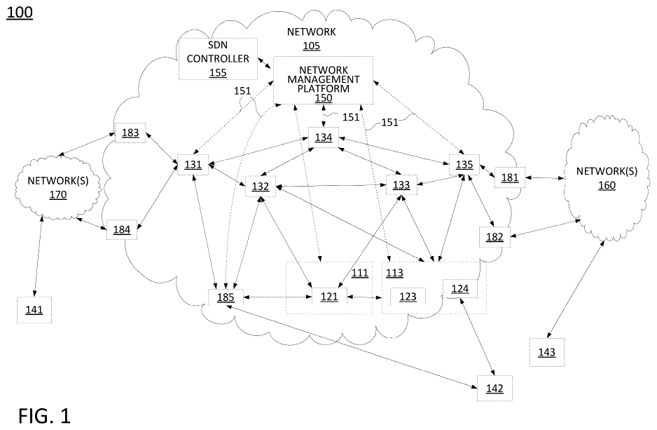

Notably, regional MLMs may miss out on the diverse data patterns from different regions. For example, a model trained only on Philadelphia's data during hurricane season may not perform well in Dallas, where the primary issues might be hardware related. Likewise, a model trained separately in Dallas might not recognize patterns indicative of weather-related disruptions common in Philadelphia. Thus, during dynamic conditions like a network-wide outage or during peak usage times, the regional MLMs trained separately may not adapt quickly enough to provide timely insights. In contrast, a federated ML-based network monitoring system and the aggregated MLM of the present disclosure may be adept at handling both weather-induced and hardware-induced issues, thus enhancing the overall network resilience. For example, during a network outage caused by a hardware failure, the aggregated MLM can identify specific patterns in metrics like packet loss and latency that precede the failure. These patterns, once recognized, can be used to trigger proactive alerts, enabling network administrators to address the issue before it escalates. Similarly, during severe weather events, the aggregated MLM can detect unusual variations in network performance metrics that typically precede weather-related outages, which may enable more timely interventions. These and other aspects of the present disclosure are discussed in greater detail below in connection with the examples of FIGS. 1-4.

To aid in understanding the present disclosure, FIG. 1 illustrates a block diagram depicting one example of a communications network or system 100 for performing or enabling the steps, functions, operations, and/or features described herein. The system 100 may include any number of interconnected networks which may use the same or different communication technologies. As illustrated in FIG. 1, system 100 may include a network 105, e.g., a core communication network. In one example, the network 105 may comprise a backbone network, or transport network, such as an Internet Protocol (IP)/multi-protocol label switching (MPLS) network, where label switched paths (LSPs) can be assigned for routing Transmission Control Protocol (TCP)/IP packets, User Datagram Protocol (UDP)/IP packets, and other types of protocol data units (PDUs) (broadly “traffic”). However, it will be appreciated that the present disclosure is equally applicable to other types of data units and network protocols. For instance, the network 105 may alternatively or additional comprise components of a cellular core network, such as a Public Land Mobile Network (PLMN), a General Packet Radio Service (GPRS) core network, and/or an evolved packet core (EPC) network, an Internet Protocol Multimedia Subsystem (IMS) network, a Voice over Internet Protocol (VoIP) network, and so forth. In one example, the network 105 uses a network function virtualization infrastructure (NFVI), e.g., servers in a data center or data centers that are available as host devices to host virtual machines (VMs) comprising virtual network functions (VNFs). In other words, at least a portion of the network 105 may incorporate software-defined network (SDN) components.

In this regard, it should be noted that as referred to herein, “traffic” may comprise all or a portion of a transmission, e.g., a sequence or flow, comprising one or more packets, segments, datagrams, frames, cells, PDUs, service data unit, bursts, and so forth. The particular terminology or types of data units involved may vary depending upon the underlying network technology. Thus, the term “traffic” is intended to refer to any quantity of data to be sent from a source to a destination through one or more networks.

In one example, the network 105 may be in communication with networks 160 and networks 170. Networks 160 and 170 may comprise wireless networks (e.g., an Institute of Electrical and Electronics Engineers (IEEE) 802.11/Wi-Fi network and the like), a cellular access network (e.g., a Universal Terrestrial Radio Access Network (UTRAN) or an evolved UTRAN (eUTRAN), an open radio access network (ORAN), and the like), a circuit switched network (e.g., a public switched telephone network (PSTN)), a cable network, a digital subscriber line (DSL) network, a metropolitan area network (MAN), an Internet service provider (ISP) network, a peer network, and the like. In one example, the networks 160 and 170 may include different types of networks. In another example, the networks 160 and 170 may be the same type of network. The networks 160 and 170 may be controlled or operated by a same entity as that of network 105 or may be controlled or operated by one or more different entities. In one example, the networks 160 and 170 may comprise separate domains, e.g., separate routing domains as compared to the network 105. In one example, networks 160 and/or networks 170 may represent the Internet in general.

In one example, network 105 may transport traffic to and from user devices 141-143. For instance, the traffic may relate to communications such as voice telephone calls, video and other multimedia, text messaging, emails, and so forth among the user devices 141-143, or between the user devices 141-143 and other devices that may be accessible via networks 160 and 170. User devices 141-143 may comprise, for example, cellular telephones, smart phones, personal computers, other wireless and wired computing devices, private branch exchanges, customer edge (CE) routers, media terminal adapters, cable boxes, home gateways and/or routers, and so forth.

In accordance with the present disclosure, user devices 141-143 may access network 105 in various ways. For example, user device 141 may comprise a cellular telephone which may connect to network 105 via network 170, e.g., a cellular access network. For instance, such an example network 170 may include one or more cell sites, e.g., comprising, a base transceiver station (BTS), a NodeB, an evolved NodeB (eNodeB), or the like (broadly a “base station”), or components thereof, e.g., a remote radio head (RRH) and baseband unit (BBU), a centralized unit (CU), a distributed unit (DU), and/or a radio unit (RU), and so forth. In addition, in such an example, components 183 and 184 in network 105 may comprise an access management function (AMF), a user plane function (UPF), a serving gateway (SGW), a mobility management entity (MME), a packet data network gateway (PGW), or the like. In one example, user device 142 may comprise a customer edge (CE) router which may provide access to network 105 for additional user devices (not shown) which may be connected to the CE router. For instance, in such an example, component 185 may comprise a provider edge (PE) router.

As mentioned above, various components of network 105 may comprise virtual network functions (VNFs) which may physically comprise hardware executing computer-readable/computer-executable instructions, code, and/or programs to perform various functions. As illustrated in FIG. 1, units 123 and 124 may reside on a network function virtualization infrastructure (NFVI) 113, which is configurable to perform a broad variety of network functions and services. For example, NFVI 113 may comprise shared hardware, e.g., one or more host devices comprising line cards, central processing units (CPUs), or processors, memories to hold computer-readable/computer-executable instructions, code, and/or programs, and so forth. For instance, in one example unit 123 may be configured to be a firewall, a media server, a Simple Network Management protocol (SNMP) trap, etc., and unit 124 may be configured to be a PE router, e.g., a virtual provide edge (VPE) router, which may provide connectivity to network 105 for user devices 142 and 143. In one example, NFVI 113 may represent a single computing device. Accordingly, units 123 and 124 may physically reside on the same host device. In another example, NFVI 113 may represent multiple host devices such that units 123 and 124 may reside on different host devices. In one example, unit 123 and/or unit 124 may have functions that are distributed over a plurality of host devices. For instance, unit 123 and/or unit 124 may be instantiated and arranged (e.g., configured/programmed via computer-readable/computer-executable instructions, code, and/or programs) to provide for load balancing between two processors and several line cards that may reside on separate host devices.

In one example, network 105 may also include an additional NFVI 111. For instance, unit 121 may be hosted on NFVI 111, which may comprise host devices having the same or similar physical components as NFVI 113. In addition, NFVI 111 may reside in a same location or in different locations from NFVI 113. As illustrated in FIG. 1, unit 121 may be configured to perform functions of an internal component of network 105. For instance, due to the connections available to NFVI 111, unit 121 may not function as a PE router, an AMF, a UPF, a SGW, a MME, a firewall, etc. Instead, unit 121 may be configured to provide functions of components that do not utilize direct connections to components external to network 105, such as a call control element (CCE), a media server, a domain name service (DNS) server, a session management function (SMF), a gateway mobile switching center (GMSC), a short message service center (SMSC), etc.

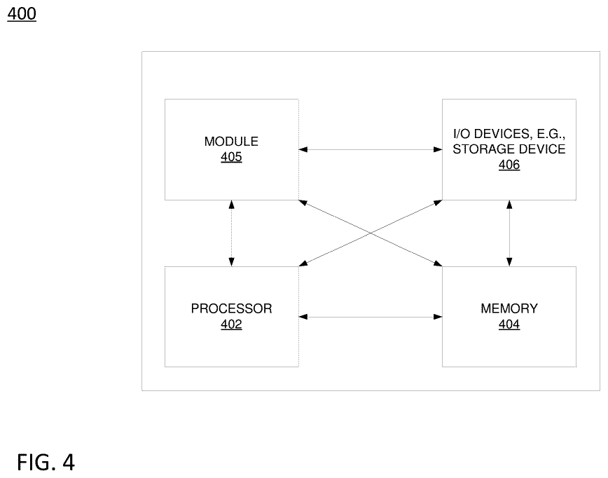

As further illustrated in FIG. 1, network 105 includes a software defined network (SDN) controller 155. In one example, the SDN controller 155 may comprise a computing system or server, such as computing system 400 depicted in FIG. 4, and may be configured to provide one or more operations or functions in connection with examples of the present disclosure for tuning an aggregated machine learning model in accordance with first parameters of a first machine learning model relating to a first network zone and second parameters of a second machine learning model relating to a second network zone. In addition, it should be noted that as used herein, the terms “configure,” and “reconfigure” may refer to programming or loading a processing system with computer-readable/computer-executable instructions, code, and/or programs, e.g., in a distributed or non-distributed memory, which when executed by a processor, or processors, of the processing system within a same device or within distributed devices, may cause the processing system to perform various functions. Such terms may also encompass providing variables, data values, tables, objects, or other data structures or the like which may cause a processing system executing computer-readable instructions, code, and/or programs to function differently depending upon the values of the variables or other data structures that are provided. As referred to herein a “processing system” may comprise a computing device including one or more processors, or cores (e.g., a computing system as illustrated in FIG. 4 and discussed below) or multiple computing devices collectively configured to perform various steps, functions, and/or operations in accordance with the present disclosure. In various examples, SDN controller 155 may alternatively or additionally comprise a self-optimizing network (SON) orchestrator, a service and management orchestrator (SMO), a radio access network (RAN) intelligent controller (RIC), or the like.

In one example, NFVI 111 and unit 121, and NFVI 113 and units 123 and 124 may be controlled and managed by the SDN controller 155. For instance, in one example, SDN controller 155 is responsible for such functions as provisioning and releasing instantiations of VNFs to perform the functions of routers, switches, and other devices, provisioning routing tables and other operating parameters for the VNFs, and so forth. In one example, SDN controller 155 may maintain communications with VNFs and/or host devices/NFVI via a number of control links which may comprise secure tunnels for signaling communications over an underling IP infrastructure of network 105. In other words, the control links may comprise virtual links multiplexed with transmission traffic and other data traversing network 105 and carried over a shared set of physical links. For ease of illustration the control links are omitted from FIG. 1. In one example, the SDN controller 155 may also comprise a virtual machine operating on NFVI/host device(s), or may comprise a dedicated device. For instance, SDN controller 155 may be collocated with one or more VNFs, or may be deployed in a different host device or at a different physical location.

The functions of SDN controller 155 may include the selection of NFVI from among various NFVI available in network 105 (e.g., NFVI 111 or 113) to host various devices, such as routers, gateways, switches, etc., and the instantiation of such devices. For example, with respect to units 123 and 124, SDN controller 155 may download computer-executable/computer-readable instructions, code, and/or programs (broadly “configuration code”) for units 123 and 124 respectively, which when executed by a processor of the NFVI 113, may cause the NFVI 113 to perform as a PE router, a gateway, a route reflector, an AMF, a SMF, a UPF, a SGW, a MME, a firewall, a media server, a DNS server, a PGW, a GMSC, a SMSC, a CCE, and so forth. In one example, SDN controller 155 may download the configuration code to the NFVI 113. In another example, SDN controller 155 may instruct the NFVI 113 to load the configuration code previously stored on NFVI 113 and/or to retrieve the configuration code from another device in network 105 that may store the configuration code for one or more VNFs. The functions of SDN controller 155 may also include releasing or decommissioning unit 123 and/or unit 124 when no longer required, the transferring of the functions of units 123 and/or 124 to different NFVI, e.g., when NVFI 113 is taken offline, and so on.

In addition, in one example, SDN controller 155 may represent a processing system comprising a plurality of controllers, e.g., a multi-layer SDN controller, one or more federated layer 0/physical layer SDN controllers, and so forth. For instance, a multi-layer SDN controller may be responsible for instantiating, tearing down, configuring, reconfiguring, and/or managing layer 2 and/or layer 3 VNFs (e.g., a network switch, a layer 3 switch and/or a router, etc.), whereas one or more layer 0 SDN controllers may be responsible for activating and deactivating optical networking components, for configuring and reconfiguring the optical networking components (e.g., to provide circuits/wavelength connections between various nodes or to be placed in idle mode), for receiving management and configuration information from such devices, for instructing optical devices at various nodes to engage in testing operations in accordance with the present disclosure, and so forth. In one example, the layer 0 SDN controller(s) may in turn be controlled by the multi-layer SDN controller. For instance, each layer 0 SDN controller may be assigned to nodes/optical components within a portion of the network 105. In addition, these various components may be co-located or distributed among a plurality of different dedicated computing devices or shared computing devices (e.g., NFVI) as described herein.

As illustrated in FIG. 1, network 105 may also include internal nodes 131-135, which may comprise various components, such as routers, switches, route reflectors, etc., cellular core network, IMS network, and/or VoIP network components, and so forth. In one example, these internal nodes 131-135 may also comprise VNFs hosted by and operating on additional NFVIs. For instance, as illustrated in FIG. 1, internal nodes 131 and 135 may comprise VNFs residing on additional NFVI (not shown) that are controlled by SDN controller 155 via additional control links. However, at least a portion of the internal nodes 131-135 may comprise dedicated devices or components, e.g., non-SDN reconfigurable devices.

Similarly, network 105 may also include components 181 and 182, e.g., PE routers interfacing with networks 160, and component 185, e.g., a PE router which may interface with user device 142. For instance, in one example, network 105 may be configured such that user device 142 (e.g., a CE router) is dual-homed. In other words, user device 142 may access network 105 via either or both of unit 124 and component 185. As mentioned above, components 183 and 184 may comprise an AMF, a SMF, a UPF, a PGW, a serving gateway (SGW), a mobility management entity (MME), or the like. However, in another example, components 183 and 184 may also comprise PE routers interfacing with network(s) 170, e.g., for non-cellular network-based communications. In one example, components 181-185 may also comprise VNFs hosted by and operating on additional NFVI. However, in another example, at least a portion of the components 181-185 may comprise dedicated devices or components.

In one example, network 105 further includes a network management platform 150. The network management platform 150 may comprise a computing system or server, such as computing system 400 depicted in FIG. 4, and may be configured to provide one or more operations or functions in connection with examples of the present disclosure for tuning an aggregated machine learning model in accordance with first parameters of a first machine learning model relating to a first network zone and second parameters of a second machine learning model relating to a second network zone. For instance, network management platform 150 may obtain network status information of network 105 (and/or networks 160, 170, etc.). The network status information may include measured performance indicator values, e.g., “key performance indicators” (KPIs) such as peak and average processor utilization, average memory utilization, bandwidth utilization, or the like, packet loss rate, call failure rate, call drop rate, packet delay, packet throughput, jitter, signal to noise (SNR) ratio, measurements of a video uplink data rate and/or measurements of a video downlink data rate, video multi-method assessment fusion (VMAF) metrics, and so forth. The network status information may also include network configuration settings (e.g., of network functions (NFs) in network 105, networks 160 and/or 170, and so forth), such as setting values, and/or a network topology, which may be indicated by the setting values, etc.

The network status information may be obtained from various devices in the network 105. For instance, the devices may send network status information to network management platform 150, or any one or more of internal nodes 131-135, components 181-185, units 121, 123, and 124, NFVI 111 and 113, may comprise aggregation points for collecting network status information and forwarding the network status information to the network management platform 150. In addition, the network management platform 150 may select first data samples relating to a first network zone (e.g., a geographic region, a domain, a tracking area, etc.) and second data samples relating to a second network zone from the network status information. The network management platform 150 may then train a first machine learning model (MLM) for a first prediction task associated with the first network zone using the first data samples. The network management platform 150 may additionally train a second MLM for a second prediction task associated with the second network zone using the second data samples (e.g., where the first prediction task and the second prediction task are both of a same type of prediction task), and so forth for other MLMs for other network zones. For example, the prediction task may include network anomaly detection/forecasting (e.g., where the network anomaly may be a network failure event (e.g., complete loss of service, failure to meet a service level agreement (SLA) or internal performance indicator/KPI benchmark(s)), an occurrence of malicious network activity, or the like.

The network management platform 150 may further tune an aggregated MLM in accordance with first parameters of the first MLM and second parameters of the second MLM. For instance, the tuning may include generating third parameters for the aggregated MLM based on/as a function of complementary/corresponding parameters from the first parameters and the second parameters. Once tuned, the network management platform 150 may apply an input data vector to the aggregated MLM to obtain an output in accordance with the first type of prediction task.

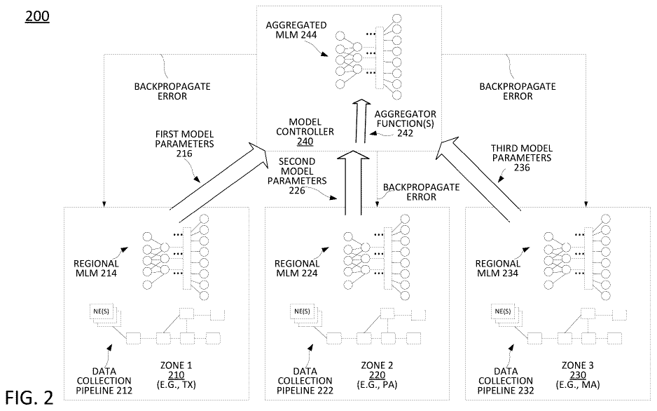

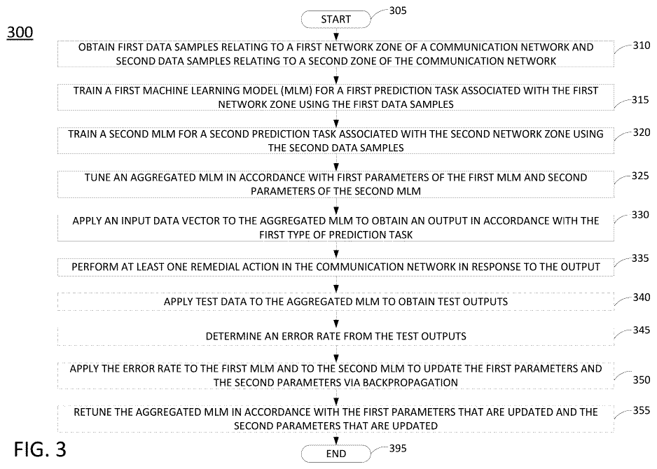

The network management platform 150 may then perform at least one remedial action in response to the output/prediction. For instance, the remedial action may include transmitting at least one notification (e.g., an alert or alarm, which may be in response to the output/prediction alone or in combination with other outputs, predictions, alarms, etc., e.g., from other anomaly detection models or the like, or the same aggregated MLM with respect to one or more other input vectors). Alternatively, or in addition, the at least one remedial action may include presenting at least one visualization, e.g., on a display screen of a computing device of one or more network personnel, etc. In one example, the at least one remedial action may include reconfiguring at least one aspect of the network 105, network(s) 160, and/or network(s) 170 in response to the output/prediction. For instance, the network management platform 150 may block network traffic of a first node, throttle the network traffic of the first node, remove payloads of packets of the network traffic of the first node, and so forth. For instance, the network management platform 150 may notify or instruct SDN controller 155 to configure or reconfigure one or more components of network 105 to reroute the traffic of the first node, to slow the traffic of the first node, and so forth. In this regard, network management platform 150 and/or SDN controller 155 may instantiate at least a second node to replace the first node for a network service and/or redirect traffic of the network service for the first node to the at least the second node. For instance, inbound or outbound traffic of the first node may be additionally filtered, e.g., by a firewall, a sandbox, a malware detection system, or the like which may pass the traffic if cleared as non-malicious, or dropped, quarantined, stripped of payload, and so forth, if not cleared and/or if specifically identified as a known threat. Similarly, the node may be decommissioned (if a VM, container or the like on NFVI 111 or 113) in response to the output/prediction. Similarly, the at least one remedial action may include blocking network traffic in the communication network, re-routing network traffic, assigning network traffic to a particular class, reducing throughput of the network traffic in the communication network, or the like. With respect to RAN/edge network monitoring, the remedial action may include instructions, e.g., to perform further action(s), such as reconfiguring a RAN (including adjusting tilt, azimuth, beamwidth, transmit power, bearer allocations, etc.), blocking traffic, re-routing traffic, rate-limiting traffic, instantiating/activating or deactivating network elements (e.g., VMs, SDN components, or hardware devices, e.g., routers, antenna elements, baseband units, content distribution network (CDN) nodes, etc.), caching content, and so on. Additional functions that may be performed by network management platform 150 and/or SDN controller 155 are described in greater detail below in connection with the examples of FIGS. 2 and 3, and the following discussion.

It should be noted that the system 100 has been simplified. In other words, the system 100 may be implemented in a different form than that illustrated in FIG. 1. For example, the system 100 may be expanded to include additional networks, such as a network operations center (NOC) network, and additional network elements (not shown) such as border elements, routers, switches, policy servers, security devices, gateways, a content distribution network (CDN) and the like, without altering the scope of the present disclosure. In addition, system 100 may be altered to omit various elements, substitute elements for devices that perform the same or similar functions and/or combine elements that are illustrated as separate devices. In still another example, SDN controller 155, network management platform 150, and/or other network elements may comprise functions that are spread across several devices that operate collectively as a SDN controller, a network management platform, an edge device, etc.

For instance, in one particular example, the network management platform 150 may include physically distinct components, where network status information for different network zones (e.g., geographic regions, such a metro regions, states, etc., domains, tracking areas, or the like) may be collected and stored at separate hardware storage components. Similarly, regional MLMs may be trained and hosted/deployed on physically distinct (and regionally distributed) hardware component, while an aggregated MLM may be trained via hardware associated with one of the regional MLMs (e.g., at a same data center) and/or at a separate hardware component (e.g., in a centralized data center that may not be associated with a particular region), and so forth. In one example, the network management platform 150 may comprise a network data analytics function (NWDAF) that may collect and store network status information, and that may train and deploy one or more MLMs (e.g., regional MLMs and/or an aggregated MLM of the present disclosure, as well as other MLMs for various other network operational tasks, such as general network tuning/configuration unrelated to anomalies or failure events, etc.). In one example, the network management platform 150 may comprise a plurality of NWDAF instances, e.g., one per network zone/region and optionally an NWDAF instance associated with the aggregated MLM. For instance, regional MLMs may be trained with local data at regional NWDAFs, and only the parameters thereof may be passed to a NWDAF associated with the aggregated MLM for parameter tuning as described herein. Thus, these and other modifications of the system 100 are all contemplated within the scope of the present disclosure.

FIG. 2 illustrates an example federated machine learning model platform 200 in accordance with the present disclosure. For example, the federated machine learning model platform 200 may be implemented by a network management platform, such as network management platform 150 of FIG. 1. In one particular example, the components/modules of federated machine learning model platform 200 may be distributed, e.g., operating on different hardware in different network locations, such as in respective data centers. For instance, the data collection pipelines 212, 222, and 232 may exist within respective zones, zone 1 (210), zone 2 (220), and zone 3 (230), e.g., associated with respective geographic regions such as Texas (TX), Pennsylvania (PA), and Massachusetts (MA). The data collection pipelines 212, 222, and 232 may include source network elements (NEs) (which may include hardware components, VNF(s), etc., which may collect and report various performance metrics and/or configuration settings), various intermediate network elements (such as data stream processing elements, database servers, etc. which may temporarily store, aggregate, cleanse, and transform the data), and so forth. In addition, each of the zones 1-3 may include respective regional MLMs 214, 224, and 234, which may all be configured for the same detection/prediction task, but with regard to the respective regions. In particular, the regional MLMs 214, 224, and 234 may be trained with training data selected from the data from data collection pipelines 212, 222, and 232, respectively, to perform the same type of detection/prediction task (e.g., detecting a network anomaly such a network failure relating to a network element or system within the network, predicting network states indicative of network anomalies, detecting malicious network activity, etc.).

It should be noted that as referred to herein, a machine learning model (MLM) (or machine learning-based model) may comprise a machine learning algorithm (MLA) that has been “trained” or configured in accordance with input training data to perform a particular service. For instance, an MLM may comprise a deep learning neural network, or deep neural network (DNN), a convolutional neural network (CNN), a recurrent neural network (RNN), a long short-term memory (LSTM) model, a generative adversarial network (GAN), a decision tree algorithm/model, such as gradient boosted decision tree (GBDT) (e.g., XGBoost, XGBR, or the like), a variational autoencoder, and so forth. In one example, one or more MLMs of the present disclosure may include supervised learning and/or reinforcement learning (e.g., using positive and negative examples after deployment as a MLM), and so forth. In one example, MLAs/MLMs of the present disclosure may be in accordance with an open source library, such as OpenCV, which may be further enhanced with domain specific training data.

In one example, MLMs of the present disclosure may include an ML-based generative model, such as a language model, e.g., a “large language model” (LLM). For instance, an ML-based generative model used in the present examples may comprise a generative adversarial network (GAN), a bidirectional encoder representations from transformers (BERT) model (e.g., BERT-Base, BERT-Large, etc.), a generative pre-training (GPT) model (e.g. GPT, GPT-2, GPT-3, or the like), a semantic graphs-based pre-training (SGPT) model, or other generative natural language processing (NLP) models. In one example, MLMs of the present disclosure may comprise an ada text embedding model.

Alternatively, or in addition, MLMs of the present disclosure may include time series forecasting/prediction models. For instance, the time series prediction/forecasting model may comprise a moving average (MA) model, an autoregressive distributed lag (ADL) model, an autoregressive integrated moving average (ARIMA) model, a seasonal ARIMA (SARIMA) model, or the like. Similarly, other regression-based models may be trained and used for such prediction/forecasting, such as logistic regression, polynomial regression, ridge regression, lasso regression, etc. In one example, the present disclosure may predict/forecast using multiple factors as predictors (e.g., covariates, or exogenous factors). For instance, a seasonal auto-regressive integrated moving average with exogenous factors (SARIMAX) model may be used. Alternatively, a vector auto-regression (VAR), or VAR moving average (VARMA) model may be used. Similarly, a vector auto-regression moving-average with exogenous factors/regressors (VARMAX) model may be applied.

The regional MLMs 214, 224, and 234 may be trained, e.g., until a desired performance (e.g., accuracy) is obtained. In addition, once trained, first model parameters 216, second model parameters 226, and third model parameters 236 may be copied from the respective regional MLMs 214, 224, and 234 and passed to the model controller 240. For instance, the model controller 240 may represent a processing system, such as network management platform 150 of FIG. 1, which is configured to generate/tune parameters of aggregated MLM 244 based on the first model parameters 216, second model parameters 226, and third model parameters 236. For instance, the model controller 240 may generate parameters of the aggregated MLM 244 using one or more aggregator functions 242. For instance, in one example, each parameter of the aggregated MLM 244 may be generated based on one of the aggregator function(s) 242, e.g., as a function of respective complementary/corresponding parameters from each of the first model parameters 216, second model parameters 226, and third model parameters 236. In particular, each of the regional MLMs 214, 224, and 234 (as well as the aggregated MLM 244) may be of a same type, and where each of the regional MLMs 214, 224, and 234 may be trained for the same prediction task. Thus, the number and types of parameters may be the same (e.g., the same number of layers, the same number of neurons, the same number of inputs in an input layer, the same number of outputs in an output layer, etc.). As such, the node weights and/or biases for a node/neuron in a particular position in the aggregated MLM 244 may be based on the respective weights and/or biases for nodes/neurons in the same position in each of the regional MLMs 214, 224, and 234, respectively.

In one example, each of the aggregator function(s) 242 may be adjusted via a reinforcement learning (RL) process, e.g., using a limited training/testing data set. In particular, the bulk of the data from data collection pipelines 212, 222, and 232 may remain within the respective zones 1-3. However, a testing data set, or a select training data set may be curated from the respective zones 1-3 (e.g., 1% of the data samples, 0.1% of the data samples, etc.) for use in RL for tuning the aggregator function(s) 242 (e.g., formulas) for combining two or more of the first model parameters 216, second model parameters 226, and third model parameters 236. For instance, for each parameter of the aggregated MLM 244, a respective one of the aggregator function(s) 242 may begin as a proportional averaging of corresponding ones of the first model parameters 216, second model parameters 226, and third model parameters 236. Over time, and over many iterations, the weights/coefficients of the formula may be adjusted through RL. It should be noted that in some examples, such formulas/functions may include non-linear features, such as coefficients for terms relating to a square or cube of source parameter, and so forth.

In addition to the use of a limited set of training/testing data for RL-based adjustment/learning of the aggregator function(s) 242, in one example, these samples may also be used for accuracy/error benchmarking of the aggregated MLM 244 (where the parameters of aggregated MLM 244 have been tuned in accordance with the foregoing). In one example, the error rate may be applied to the respective regional MLMs 214, 224, and 234 to update the first model parameters 216, the second model parameters 226, and the third model parameters 236 via backpropagation. In turn, the updated first model parameters 216, updated second model parameters 226, and updated third model parameters 236 may be passed to the model controller 240 for use in updating the parameters of the aggregated MLM 244 in the same or similar manner as described above.

In one example, the aggregated MLM 244 may be deployed for live prediction/forecasting, e.g., anomaly detection, from a centralized location and/or may be copied to the respective zones 1-3 for local prediction within each of the respective zones 1-3. Notably, the aggregated MLM 244 may be adept at recognizing and detecting anomalies of various types based on data patterns which may be observed in different zones. Thus, a severe weather event may threaten zone 3 for the first time. However, if zone 1 has experienced a similar severe weather event that resulted in outages, e.g., in Texas, the aggregated MLM 244 may be capable of accurate detection/prediction of outages in zone 3 (e.g., Massachusetts) insofar as its parameters have been influenced by the training/learning incorporated into the regional MLM 214 and passed to the model controller 240 as the third model parameters 236.

It should be noted that the foregoing describes just one example of a machine learning model platform 200 in accordance with the present disclosure and that other, further, and different examples may be devised in accordance with the present disclosure. For instance, although three zones are illustrated in the example of FIG. 2, other examples may include more or less zones (e.g., two zones, five zones, eight zones, etc.). In one example, zones (e.g., regions or the like) may be organized hierarchically into more than two levels. For instance, there may be numerous city-level MLMs, followed by a plurality of regional MLMs that may have parameters tuned similar to aggregated MLM 244. In addition, there may be a global MLM having parameters tuned based on parameters of the regional MLMs, and so forth. Thus, these and other modifications are all contemplated within the scope of the present disclosure.

FIG. 3 illustrates a flowchart of an example method 300 for tuning an aggregated machine learning model in accordance with first parameters of a first machine learning model relating to a first network zone and second parameters of a second machine learning model relating to a second network zone, in accordance with the present disclosure. In one example, the method 300 is performed by a component of the system 100 of FIG. 1, such as by network management platform 150, and/or any one or more components thereof (e.g., a processor, or processors, performing operations stored in and loaded from a memory), or by network management platform 150 in conjunction with one or more other devices, such as SDN controller 155, and so forth. In one example, the steps, functions, or operations of method 300 may be performed by a computing device or system 400, and/or processor 402 as described in connection with FIG. 4 below. For instance, the computing device or system 400 may represent any one or more components of network management platform 150, SDN controller 155, etc. in FIG. 1 that is/are configured to perform the steps, functions and/or operations of the method 300. Similarly, in one example, the steps, functions, or operations of method 300 may be performed by a processing system comprising one or more computing devices collectively configured to perform various steps, functions, and/or operations of the method 300. For instance, multiple instances of the computing device or processing system 400 may collectively function as a processing system. For illustrative purposes, the method 300 is described in greater detail below in connection with an example performed by a processing system. The method 300 begins in step 305 and proceeds to step 310.

At step 310, the processing system obtains first data samples relating to a first network zone of a communication network and second data samples relating to a second zone of the communication network. In one example, the first network zone may be associated with a first geographic area and the second network zone may be associated with a second geographic area. Alternatively, or in addition, the network zones may comprise respective routing domains, tracking area, etc. In one example, the first data samples may further relate to a first endpoint device type within the first network zone while the second data samples may further relate to the first endpoint device type within the second network zone. Similarly, in one example, the first data samples may further relate to a first data traffic type within the first network zone while the second data samples may further relate to the first data traffic type within the second network zone. In still another example, the first data samples may further relate to a first network function type within the first network zone while the second data samples may further relate to the first network function type within the second network zone. In other words, the data may be segregated for MLMs that are particularized according to one or more other factors besides network zone or geographic location (e.g., demographics, device types, communication types, application types, etc.).

In addition, the first data samples may comprise first network status information and the second data samples comprise second network status information, e.g., for the respective network zones. For instance, as noted above, network status information may include measured performance indicators such as peak and average processor utilization, average memory utilization, bandwidth utilization, or the like, packet loss rate, call failure rate, call drop rate, packet delay, packet throughput, jitter, signal to noise (SNR) ratio, measurements of a video uplink data rate and/or measurements of a video downlink data rate, VMAF metrics, and so forth. In accordance with the present disclosure, network status information may also include network configuration settings for various network elements/network functions, such as setting values for various configurable settings and/or a network topology, which may be indicated by the setting values, or otherwise.

At step 315, the processing system trains a first machine learning model (MLM) for a first prediction task associated with the first network zone using the first data samples.

At step 320, the processing system trains a second MLM for a second prediction task associated with the second network zone using the second data samples, where the first prediction task and the second prediction task are both of a same first type of prediction task. For instance, the first MLM and the second MLM may be of a same machine learning model type, such as one of: a time series prediction model type, a deep neural network model type, a recurrent neural network, a long short-term memory model type, a language model type, or the like. To further illustrate, the prediction task may comprise a network anomaly detection task (e.g., where the network anomaly may comprise a network failure event, an occurrence of malicious network activity, etc.). In this regard, it should be noted that the failure may comprise a complete loss of service, or could be a failure to meet a SLA or internal performance indicator/KPI benchmark(s).

At step 325, the processing system tunes an aggregated MLM in accordance with first parameters of the first MLM and second parameters of the second MLM, where the tuning comprises generating third parameters for the aggregated MLM as a function of complementary parameters from the first parameters and the second parameters. For instance, the first parameters and the second parameters may each comprise one or more of: neuron (or node) weights, neuron biases, gate weights, a learning rate parameter, a lookback window parameter, an ageing parameter, and/or the like. In one example, the tuning of the aggregated machine learning model may include generating a respective one of the third parameters from a corresponding one the first parameters and a corresponding one of the second parameters in accordance with a first function.

To further illustrate, the first function may comprise a formula that defines a combination of the corresponding one of the first parameters and the corresponding one of the second parameters. In one example, the first function may be adjusted via a reinforcement learning (RL) process. In one example, the tuning of the aggregated MLM may include generating each of the third parameters using a respective function of a plurality of functions, where the plurality of functions includes the first function (and in one example, where each function of the plurality of functions is adjusted via a RL process, e.g., using the same or new/updated testing data). It should again be noted that the training data of steps 310-320 may remain localized, while a limited set of testing data may be accessible to the aggregated MLM for accuracy/error benchmarking, for RL-based tuning of the formulas, for combining parameters from the first MLM and the second MLM, and/or for backpropagation.

At step 330, the processing system applies an input data vector to the aggregated MLM to obtain an output in accordance with the first type of prediction task. In various examples, the input data vector may be associated with at least one of: the first network zone, the second network zone, or a third network zone. In other words, in one example, the aggregated machine learning model may be used in other zones besides the zones having MLMs from which the aggregated MLM is derived.

At step 335, the processing system performs at least one remedial action in the communication network in response to the output. In various examples, the at least one remedial action may be with respect to at least one of: the first network zone, the second network zone, or a third network zone (or could be in a core network that is equally serving different zones, e.g., the remedial action need not be zone-specific, even if the output prediction relates to a particular zone or occurrence within a zone). In one example, the at least one remedial action may include presenting at least one visualization, e.g., on a display screen of a computing device of one or more network personnel, etc. In one example, the at least one remedial action may include reconfiguring at least one aspect of the communication network in response to the output/prediction. For instance, the processing system may block or throttle network traffic to or from one or more endpoint devices, customer premises, fiber nodes, etc., may block or throttle network traffic for one or more physical links in the network, for one or more traffic flows, for one or more network slices, for one or more tunnels or virtual private networks, and so forth, e.g., depending on the particular type of network anomaly, the location of the anomaly or the affected route, network element/network function, customer premises, endpoint device(s), etc., and so forth. In one example, the processing system may perform the remedial actions directly (e.g., via instructions to the network elements/network functions where configuration changes are to be implemented) or may notify or instruct a SDN controller, SMO, RIC, or the like to configure or reconfigure one or more components of the communication network to reroute traffic, to slow the traffic, to instantiate or de-instantiate VNFs, and so forth. With respect to RAN/edge network monitoring, the remedial action may include instructions, e.g., to perform further action(s), such as reconfiguring a RAN (including adjusting tilt, azimuth, beamwidth, transmit power, bearer allocations, etc.), blocking traffic, re-routing traffic, rate-limiting traffic, instantiating/activating or deactivating network elements (e.g., VMs, SDN components, or hardware devices, e.g., routers, antenna elements, baseband units, content distribution network (CDN) nodes, etc.), caching content, and so on.

At optional step 340, the processing system may apply test data to the aggregated MLM to obtain test outputs. For instance, as noted above, a limited selection of test data may be made available for accuracy/error rate determination of the aggregated MLM, for RL tuning, and/or for backpropagation. Thus, the test data sample inputs may be applied to the aggregated MLM and to obtain respective outputs.

At optional step 345, the processing system may determine an error rate from the test outputs. For instance, the outputs may be compared to the labels (e.g., the known correct outputs) of the test data samples. Any deviations may be quantified as an error. The error rate may comprise the error over one or a plurality of test data samples (e.g., an average error/deviation, such as in accordance with a distance between the generated output and the label/known correct output in a vector space, or a difference for a single dimensional output).

At optional step 350, the processing system may apply the error rate to the first MLM and to the second MLM to update the first parameters and the second parameters via backpropagation. For instance, weights, biases, or the like may be updated moving backwards from an output layer toward an input layer of each of the first MLM and the second MLM according to a backpropagation algorithm/function.

At optional step 355, the processing system may retune the aggregated MLM in accordance with the first parameters that are updated and the second parameters that are updated. For instance, optional step 355 may comprise the same or similar operations as described above in connection with step 325.

Following step 335, optional step 350, or optional step 355, the method 300 proceeds to step 395 where the method ends.

It should be noted that the method 300 may be expanded to include additional steps, or may be modified to replace steps with different steps, to combine steps, to omit steps, to perform steps in a different order, and so forth. For instance, in various examples, the processing system may repeat one or more steps of the method 300, such as steps 340-350 and/or steps 340-355 for additional reinforcement learning and/or MLM updating via backpropagation, steps 330-335 for additional live anomaly detection/prediction and remediation, and so forth. In one example, the method 300 may be expanded or modified to include steps, functions, and/or operations, or other features described above in connection with the example(s) of FIG. 1 and/or FIG. 2, or as described elsewhere herein. Thus, these and other modifications are all contemplated within the scope of the present disclosure.

In addition, although not expressly specified above, one or more steps of the method 300 may include a storing, displaying and/or outputting step as required for a particular application. In other words, any data, records, fields, and/or intermediate results discussed in the method can be stored, displayed and/or outputted to another device as required for a particular application. Furthermore, operations, steps, or blocks in FIG. 3 that recite a determining operation or involve a decision do not necessarily require that both branches of the determining operation be practiced. In other words, one of the branches of the determining operation can be deemed as an optional step. However, the use of the term “optional step” is intended to only reflect different variations of a particular illustrative embodiment and is not intended to indicate that steps not labelled as optional steps to be deemed to be essential steps. Furthermore, operations, steps or blocks of the above described method(s) can be combined, separated, and/or performed in a different order from that described above, without departing from the example embodiments of the present disclosure.

FIG. 4 depicts a high-level block diagram of a computing device or processing system specifically programmed to perform the functions described herein. For example, any one or more components or devices illustrated in FIG. 1 or described in connection with the method 300 may be implemented as the processing system 400. As depicted in FIG. 4, the processing system 400 comprises one or more hardware processor elements 402 (e.g., a microprocessor, a central processing unit (CPU) and the like), a memory 404, (e.g., random access memory (RAM), read only memory (ROM), a disk drive, an optical drive, a magnetic drive, and/or a Universal Serial Bus (USB) drive), a module 405 for tuning an aggregated machine learning model in accordance with first parameters of a first machine learning model relating to a first network zone and second parameters of a second machine learning model relating to a second network zone, and various input/output devices 406, e.g., a camera, a video camera, storage devices, including but not limited to, a tape drive, a floppy drive, a hard disk drive or a compact disk drive, a receiver, a transmitter, a speaker, a display, a speech synthesizer, an output port, and a user input device (such as a keyboard, a keypad, a mouse, and the like).

Although only one processor element is shown, it should be noted that the computing device may employ a plurality of processor elements. Furthermore, although only one computing device is shown in the Figure, if the method(s) as discussed above is implemented in a distributed or parallel manner for a particular illustrative example, i.e., the steps of the above method(s) or the entire method(s) are implemented across multiple or parallel computing devices, e.g., a processing system, then the computing device of this Figure is intended to represent each of those multiple computers. Furthermore, one or more hardware processors can be utilized in supporting a virtualized or shared computing environment. The virtualized computing environment may support one or more virtual machines representing computers, servers, or other computing devices. In such virtualized virtual machines, hardware components such as hardware processors and computer-readable storage devices may be virtualized or logically represented. The hardware processor 402 can also be configured or programmed to cause other devices to perform one or more operations as discussed above. In other words, the hardware processor 402 may serve the function of a central controller directing other devices to perform the one or more operations as discussed above.

It should be noted that the present disclosure can be implemented in software and/or in a combination of software and hardware, e.g., using application specific integrated circuits (ASIC), a programmable logic array (PLA), including a field-programmable gate array (FPGA), or a state machine deployed on a hardware device, a computing device, or any other hardware equivalents, e.g., computer readable instructions pertaining to the method(s) discussed above can be used to configure a hardware processor to perform the steps, functions and/or operations of the above disclosed method(s). In one example, instructions and data for the present module or process 405 for tuning an aggregated machine learning model in accordance with first parameters of a first machine learning model relating to a first network zone and second parameters of a second machine learning model relating to a second network zone (e.g., a software program comprising computer-executable instructions) can be loaded into memory 404 and executed by hardware processor element 402 to implement the steps, functions or operations as discussed above in connection with the example method 300. Furthermore, when a hardware processor executes instructions to perform “operations,” this could include the hardware processor performing the operations directly and/or facilitating, directing, or cooperating with another hardware device or component (e.g., a co-processor and the like) to perform the operations.

The processor executing the computer readable or software instructions relating to the above described method(s) can be perceived as a programmed processor or a specialized processor. As such, the present module 405 for tuning an aggregated machine learning model in accordance with first parameters of a first machine learning model relating to a first network zone and second parameters of a second machine learning model relating to a second network zone (including associated data structures) of the present disclosure can be stored on a tangible or physical (broadly non-transitory) computer-readable storage device or medium, e.g., volatile memory, non-volatile memory, ROM memory, RAM memory, magnetic or optical drive, device or diskette and the like. Furthermore, a “tangible” computer-readable storage device or medium comprises a physical device, a hardware device, or a device that is discernible by the touch. More specifically, the computer-readable storage device may comprise any physical devices that provide the ability to store information such as data and/or instructions to be accessed by a processor or a computing device such as a computer or an application server.

While various embodiments have been described above, it should be understood that they have been presented by way of example only, and not limitation. Thus, the breadth and scope of a preferred embodiment should not be limited by any of the above-described example embodiments, but should be defined only in accordance with the following claims and their equivalents.

What is claimed is:

1. A method comprising:
obtaining, by a processing system including at least one processor, first data samples relating to a first network zone of a communication network and second data samples relating to a second zone of the communication network;
training, by the processing system, a first machine learning model for a first prediction task associated with the first network zone using the first data samples;
training, by the processing system, a second machine learning model for a second prediction task associated with the second network zone using the second data samples, wherein the first prediction task and the second prediction task are both of a same first type of prediction task;
tuning, by the processing system, an aggregated machine learning model in accordance with first parameters of the first machine learning model and second parameters of the second machine learning model, wherein the tuning comprises generating third parameters for the aggregated machine learning model as a function of complementary parameters from the first parameters and the second parameters;
applying, by the processing system, an input data vector to the aggregated machine learning model to obtain an output in accordance with the first type of prediction task; and
performing, by the processing system, at least one remedial action in the communication network in response to the output.

2. The method of claim 1, wherein the first network zone is associated with a first geographic area, and wherein the second network zone is associated with a second geographic area.

3. The method of claim 1, wherein the first data samples further relate to a first endpoint device type within the first network zone and wherein the second data samples further relate to the first endpoint device type within the second network zone.

4. The method of claim 1, wherein the first data samples further relate to a first data traffic type within the first network zone and wherein the second data samples further relate to the first data traffic type within the second network zone.

5. The method of claim 1, wherein the first data samples further relate to a first network function type within the first network zone and wherein the second data samples further relate to the first network function type within the second network zone.

6. The method of claim 1, wherein the first data samples comprise first network status information, and where the second data samples comprise second network status information.

7. The method of claim 6, wherein each of the first network status and the second network status information comprises at least one of:
measured performance indicator values; or
network configuration settings.

8. The method of claim 1, wherein the first machine learning model and the second machine learning model are of a same machine learning model type, wherein the machine learning model type comprises one of:
a time series prediction model type;
a deep neural network model type;
a recurrent neural network;
a long short-term memory model type; or
a language model type.

9. The method of claim 1, wherein the first type of prediction comprises a network anomaly detection task.

10. The method of claim 1, wherein the first parameters and the second parameters each comprises one or more of:
neuron weights;
neuron biases;
gate weights;
a learning rate parameter;
a lookback window parameter; or
an ageing parameter.

11. The method of claim 10, wherein the tuning of the aggregated machine learning model comprises, generating a respective one of the third parameters from a corresponding one the first parameters and a corresponding one of the second parameters in accordance with a first function.

12. The method of claim 11, wherein the first function comprises a formula that defines a combination of the corresponding one the first parameters and the corresponding one of the second parameters.

13. The method of claim 12, further comprising:
applying test data to the aggregated machine learning model to obtain test outputs;
determining an error rate from the test outputs; and
applying the error rate to the first machine learning model and to the second machine learning model to update the first parameters and the second parameters via a backpropagation.

14. The method of claim 13, further comprising:
retuning the aggregated machine learning model in accordance with the first parameters that are updated and the second parameters that are updated.

15. The method of claim 12, wherein the first function is adjusted via a reinforcement learning process.

16. The method of claim 11, wherein the tuning of the aggregated machine learning model comprises, generating each of the third parameters using a respective function of a plurality of functions, wherein the plurality of functions includes the first function.

17. The method of claim 1, wherein the at least one remedial action comprises at least one of:
transmitting at least one notification; or
presenting at least one visualization.

18. The method of claim 1, wherein the at least one remedial action comprises:
reconfiguring at least one aspect of the communication network.

19. A non-transitory computer-readable medium storing instructions which, when executed by a processing system including at least one processor, cause the processing system to perform operations, the operations comprising:
obtaining first data samples relating to a first network zone of a communication network and second data samples relating to a second zone of the communication network;
training a first machine learning model for a first prediction task associated with the first network zone using the first data samples;
training a second machine learning model for a second prediction task associated with the second network zone using the second data samples, wherein the first prediction task and the second prediction task are both of a same first type of prediction task;
tuning an aggregated machine learning model in accordance with first parameters of the first machine learning model and second parameters of the second machine learning model, wherein the tuning comprises generating third parameters for the aggregated machine learning model as a function of complementary parameters from the first parameters and the second parameters;
applying an input data vector to the aggregated machine learning model to obtain an output in accordance with the first type of prediction task; and
performing at least one remedial action in the communication network in response to the output.

20. A device comprising:
a processing system including at least one processor; and
a computer-readable medium storing instructions which, when executed by the processing system, cause the processing system to perform operations, the operations comprising:
obtaining first data samples relating to a first network zone of a communication network and second data samples relating to a second zone of the communication network;
training a first machine learning model for a first prediction task associated with the first network zone using the first data samples;
training a second machine learning model for a second prediction task associated with the second network zone using the second data samples, wherein the first prediction task and the second prediction task are both of a same first type of prediction task;
tuning an aggregated machine learning model in accordance with first parameters of the first machine learning model and second parameters of the second machine learning model, wherein the tuning comprises generating third parameters for the aggregated machine learning model as a function of complementary parameters from the first parameters and the second parameters;
applying an input data vector to the aggregated machine learning model to obtain an output in accordance with the first type of prediction task; and
performing at least one remedial action in the communication network in response to the output.
